(19) United States
(12) Patent Application Publication
(10) Pub. No.: US 2003/0174027 A1
(43) Pub. Date: Sep. 18, 2003

(54) Small-loss, large-return-loss nonreciprocal circuit device

(75) Inventor: Yuichi Shimizu, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/386,857

(22) Filed: Mar. 12, 2003

(30) Foreign Application Priority Data
Mar. 14, 2002 (JP) 2002-070024

(51) Int. Cl. H01P 1/32

(52) U.S. Cl. 333/1.1; 333/24.2

(57) ABSTRACT

A planar magnetic core is disposed in a DC magnetic field, and the top surface thereof is perpendicular to the direction of the DC magnetic field. Three central conductors are placed on the top surface of the magnetic core so that they overlap with each other at regular intervals substantially at the center of the top surface of the magnetic core. One end of each of the central conductors is used as an input/output terminal, and the other ends thereof are used as ground terminals. The inductance per unit length of the central conductor from the central portion to the ground terminal is set to be smaller than that from the central portion to the input/output terminal.

### BACKGROUND OF THE INVENTION

1. Field of the Invention

The present invention relates to nonreciprocal circuit devices utilizing the Faraday effect.

2. Description of the Related Art

The main portion of a known nonreciprocal circuit device is shown in FIG. 8. A disc-like magnetic core 21 formed of ferrite, such as yttrium-iron-garnet (YIG), is disposed in a DC magnetic field generated by a permanent magnet (not shown), and the top surface of the magnetic core 21 is perpendicular to the direction of the DC magnetic field. Three central conductors 22, 23, and 24 are placed on the top surface of the magnetic core 21, and are held so that they overlap with each other at regular intervals (120°) substantially at the center of the magnetic core 21 while being insulated from each other. The lengths of the three central conductors 22, 23, and 24 are substantially the same, and thus, the inductances are also substantially equal.

The central conductors 22, 23, and 24 include two strip-like conductor portions 22a and 22b, 23a and 23b, and 24a and 24b, respectively, opposing each other. One end of the central conductor 22 serves as an input/output terminal 22c, and the other end thereof is used as a ground terminal 22c; one end of the central conductor 23 serves as an input/output terminal 23c, and the other end thereof is used as a ground terminal 23c; and one end of the central conductor 24 serves as an input/output terminal 24c, and the other end thereof is used as a ground terminal 24d. The input/output terminals 22c, 23c, and 24c are connected to corresponding circuits (not shown), and are grounded via matching termination capacitors 25, 26, and 27, respectively, which have equal capacitances. The ground terminals 22d, 23d, and 24d are connected to corresponding grounded casings (not shown).

The central conductor 22 and the termination capacitor 25 form a resonance circuit. Similarly, the central conductor 23 and the termination capacitor 26 form a resonance circuit, and the central conductor 24 and the termination capacitor 27 form a resonance circuit. The resonant frequencies of the resonance circuits are set by the corresponding termination capacitors 25, 26, and 27 so that they become equal to the frequency of an input signal. The central conductors 22, 23, and 24 are coupled to each other, and then, a double-tuned circuit is formed, for example, between the input/output terminals 22c and 23c. Similarly, double-tuned circuits are also formed between the input/output terminals 23c and 24c and between the input/output terminals 24c and 22c.

In the above-described configuration, due to the Faraday effect, the following phenomenon occurs. A signal input into the input/output terminal 22c of the central conductor 22 is output to the input/output terminal 23c of the central conductor 23, which is displaced clockwise from the input/output terminal 22c by 120°. A signal input into the input/output terminal 23c of the central conductor 23 is output to the input/output terminal 24c of the central conductor 24, which is displaced clockwise from the input/output terminal 23c by 120°. A signal input into the input/output terminal 24c of the central conductor 24 is output to the input/output terminal 22c of the central conductor 22.

The central conductors 22, 23, and 24 overlap with each other on the magnetic core 21 such that they are extremely close to each other. Accordingly, the above-described double-tuned circuits are closely coupled to each other, and the transmission characteristic, for example, from the input/output terminal 22c to the input/output terminal 23c exhibits a double peak response, as shown in FIG. 9, and the insertion loss becomes large at frequency FO. The return loss indicating the input impedance or the output impedance at the input/output terminal also exhibits a double peak response, and becomes low (small) at frequency FO. For allowing the double-tuned circuits to critically coupled to each other, the central conductors can be separated by vertically displacing them from each other. It is difficult, however, to physically change the positional relationship among the central conductors in the vertical direction.

### SUMMARY OF THE INVENTION

Accordingly, it is an object of the present invention to decrease loss at a signal frequency and to increase return loss at input/output terminals by ensuring a required transmission band for input/output signals.

In order to achieve the above object, the present invention provides a nonreciprocal circuit device including: a planar magnetic core disposed in a DC magnetic field, a top surface of the magnetic core being perpendicular to the direction of the DC magnetic field; and three central conductors disposed to overlap with each other substantially at a central portion of the top surface of the magnetic core, one end of each of the three central conductors being used as an input/output terminal, and the other end thereof being used as a ground terminal. The inductance per unit length from the central portion to the ground terminal of each of the three central conductors is set to be smaller than that from the central portion to the input/output terminal of each of the three central conductors.

With this configuration, the inductance from the central portion to the ground terminal becomes relatively smaller than that from the central portion to the input/output terminal. Accordingly, the transmission characteristic between the input/output terminals exhibits substantially a single peak response rather than a double peak response, thereby decreasing the transmission loss. The return loss also exhibits substantially a single peak response, and the impedance matching with another circuit connected to the nonreciprocal circuit device can be provided.

Each of the three central conductors may include two strip-like conductor portions opposing each other with an equal spacing therebetween, and a short-circuiting strip for connecting the two strip-like conductor portions may be provided between the central portion and the ground terminal. With this arrangement, the inductance from the central portion to the ground terminal becomes relatively smaller than that from the central portion to the input/output terminal.

Alternatively, each of the three central conductors may include two strip-like conductor portions opposing each other, and the width of each of the strip-like conductor portions from the central portion to the ground terminal may be set to be greater than that from the central portion to the input/output terminal. With this arrangement, the inductance from the central portion to the ground terminal becomes relatively smaller than that from the central portion to the input/output terminal. Additionally, a greater width of the strip-like conductor portions toward the ground terminal decreases the current loss.

Alternatively, each of the three central conductors may include two strip-like conductor portions opposing each other, and the spacing between the two strip-like conductor portions from the central portion to the ground terminal may be set to be greater than that from the central portion to the input/output terminal. With this arrangement, the inductance from the central portion to the ground terminal becomes relatively smaller than that from the central portion to the input/output terminal.

In the above-mentioned modification, the width of each of the strip-like conductor portions from the central portion to the ground terminal may be set to be greater than that from the central portion to the input/output terminal. With this arrangement, the inductance from the central portion to the ground terminal relatively becomes much smaller than that from the central portion to the input/output terminal. Additionally, a greater width of the strip-like conductor portions toward the ground terminal decreases the current loss.

### BRIEF DESCRIPTION OF THE DRAWINGS

FIG. 1 is an exploded perspective view illustrating the main portion of a nonreciprocal circuit device according to a first embodiment of the present invention;

FIG. 2 is an equivalent circuit diagram of a non-reciprocal circuit device of the present invention;

FIG. 3 is an equivalent circuit diagram of a non-reciprocal circuit device of the present invention;

FIG. 4 is an equivalent circuit diagram of a non-reciprocal circuit device of the present invention;

FIG. 5 is a diagram illustrating a transmission characteristic of a nonreciprocal circuit device of the present invention;

FIG. 6 is an exploded perspective view illustrating the main portion of a nonreciprocal circuit device according to a second embodiment of the present invention;

FIG. 7 is an exploded perspective view illustrating the main portion of a nonreciprocal circuit device according to a third embodiment of the present invention;

FIG. 8 is an exploded perspective view illustrating the main portion of a known nonreciprocal circuit device; and

FIG. 9 is a diagram illustrating a transmission characteristic of a known nonreciprocal circuit device.

### DESCRIPTION OF THE PREFERRED EMBODIMENTS

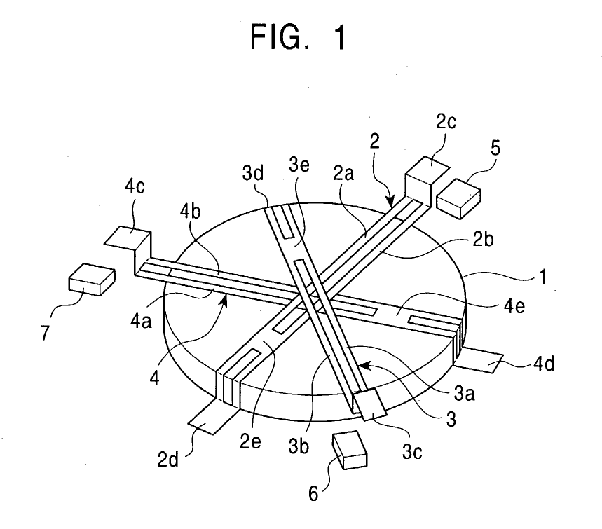

A first embodiment of the present invention is described below with reference to FIG. 1. A disc-like magnetic core 1 formed of a ferrite, such as YIG, is disposed in a DC magnetic field generated by a permanent magnet (not shown), and the top surface of the magnetic core 1 is perpendicular to the direction of the DC magnetic field. Three central conductors 2, 3, and 4 are placed on the top surface of the magnetic core 1, and are held so that they overlap with each other at regular intervals (120°) substantially at the center of the top surface of the magnetic core 1 while being insulated from each other.

The central conductors 2, 3, and 4 include two strip-like conductor portions 2a and 2b, 3a and 3b, and 4a and 4b, respectively, having the same width and opposing each other at an equal spacing therebetween. One end of the central conductor 2 serves as an input/output terminal 2c, and the other end thereof is used as a ground terminal 2d; one end of the central conductor 3 serves as an input/output terminal 3c, and the other end thereof is used as a ground terminal 3d; and one end of the central conductor 4 serves as an input/output terminal 4c, and the other end thereof is used as a ground terminal 4d. The input/output terminals 2c, 3c, and 4c are connected to corresponding circuits (not shown), and are grounded via matching capacitors 5, 6, and 7, respectively, which have equal capacitances. The ground terminals 2d, 3d, and 4d are connected to corresponding grounded casings (not shown).

The central conductor 2 and the matching capacitor 5 form a resonance circuit. Similarly, the central conductor 3 and the matching capacitor 6 form a resonance circuit, and the central conductor 4 and the matching capacitor 7 form a resonance circuit. The resonant frequencies are set by the corresponding matching capacitors 5, 6, and 7 so that they become equal to the frequency of an input signal. The central conductors 2, 3, and 4 are coupled to each other, and then, a double-tuned circuit is formed, for example, between the input/output terminals 2c and 3c. Likewise, double-tuned circuits are also formed between the input/output terminals 3c and 4c and between the input/output terminals 4c and 2c.

In the above-described configuration, due to the Faraday effect, the following phenomenon occurs. A signal input into the input/output terminal 2c of the central conductor 2 is output to the input/output terminal 3c of the central conductor 3, which is displaced clockwise from the input/output terminal 2c by 120°. A signal input into the input/output terminal 3c of the central conductor 3 is output to the input/output terminal 4c of the central conductor 4, which is displaced clockwise from the input/output terminal 3c by 120°. A signal input into the input/output terminal 4c of the central conductor 4 is output to the input/output terminal 2c of the central conductor 2.

It is now assumed that, since the central conductors 2, 3, and 4 have substantially the same length, and the lengths from the overlapping central portions to the input/output terminals 2c, 3c, and 4c of the conductors 2, 3, and 4 are equal to each other, inductances L1 thereof become substantially equal. It is also assumed that, since the lengths from the overlapping central portions to the ground terminals 2d, 3d, and 4d of the conductors 2, 3, and 4 are substantially equal, inductances L3 thereof become equal, and inductances L2 of the overlapping central portions also become equal.

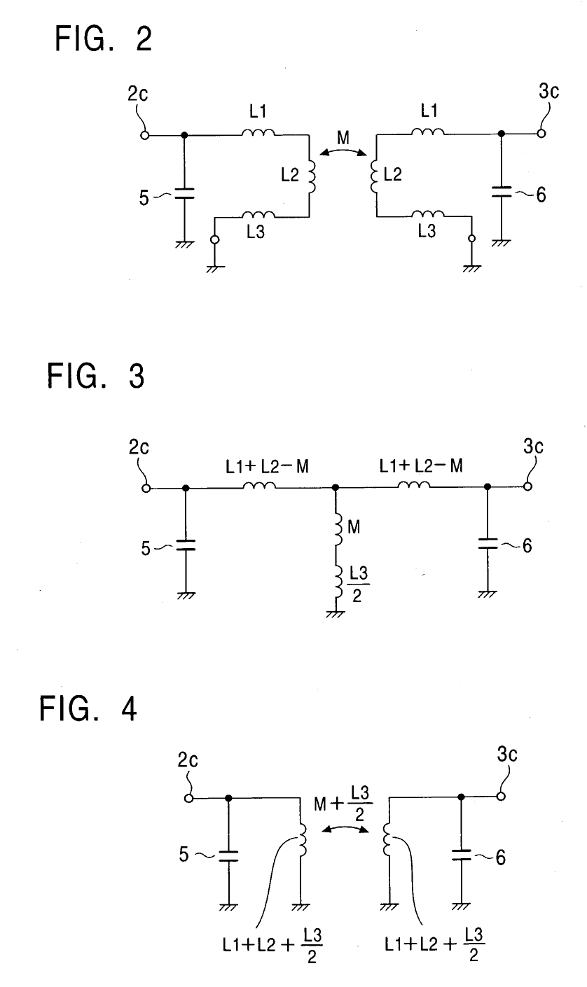

The configuration between the input/output terminals 2c and 3c can be represented by the equivalent circuit shown in FIG. 2. In FIG. 2, inductance M is the mutual inductance resulting from the coupling of inductances L2.

The equivalent circuit shown in FIG. 2 can be modified into the equivalent circuit shown in FIG. 3 or 4. Accordingly, when K represents the coupling coefficient of inductances L1+L2+L3/2, the coupling index k (different from the coupling coefficient K) of the double-tuned circuit shown in FIG. 4 is expressed by equation (1):

$$k = KQ = \frac{M + \frac{L3}{2}}{L1 + L2 + \frac{L3}{2}} Q \qquad ( 1 )$$

where M indicates the mutual inductance resulting from the coupling of inductances L2 shown in FIG. 2 (when the coupling coefficient is indicated by K1); and Q is the Q factor of the tuned circuits determined by a signal source impedance and a load impedance (having the same value as the signal source impedance) connected to the input/output terminals 2c and 3c.

The coupling index k represents the transmission characteristic of a double-tuned circuit, and the coupling index k becomes greater than 1 when the transmission characteristic exhibits a double peak response. Accordingly, when focusing on the coupling coefficient K in equation 1, the numerator M is indicated by expression: M=K1×L2, and considering that K1 is 1 or smaller, and that L2 is definitely smaller than L3, i.e., L2<L3, because of the structure of the central conductors, M can be expressed by M <L3/2. The denominator of equation (1) can be expressed as L1+L2>L3/2. Accordingly, the coupling coefficient K can be simplified into equation (2).

$$K = \frac{L3}{2 ( L1 + L2 )} \qquad ( 2 )$$

Equation 2 shows that the coupling index k can be made smaller by increasing inductances L1 and L2 and by decreasing inductance L3.

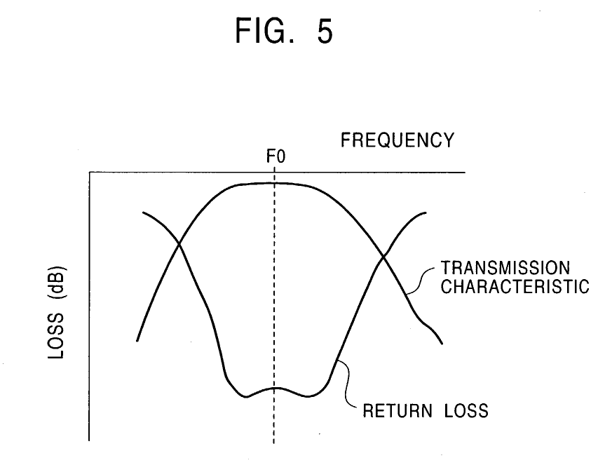

Accordingly, a short-circuiting strip 3e for partially connecting the two conductor portions 2a and 2b is provided between the overlapping central portion and the ground terminal 2d of the central conductor 2. Similarly, short-circuiting strips 3e and 4e are provided for the other central conductors 3 and 4, respectively. With this arrangement, the average inductance per unit length from the overlapping central portion to the ground terminal 2d, 3d, or 4d becomes smaller than that from the overlapping central portion to the input/output terminal 2c, 3c, or 4c, thereby decreasing the coupling index k. Thus, as shown in FIG. 5, the transmission characteristic exhibits substantially a single peak response, the loss at signal frequency FO is decreased, and the return loss indicating the input impedance or the output impedance at the input/output terminal also distinctively exhibits a single peak response.

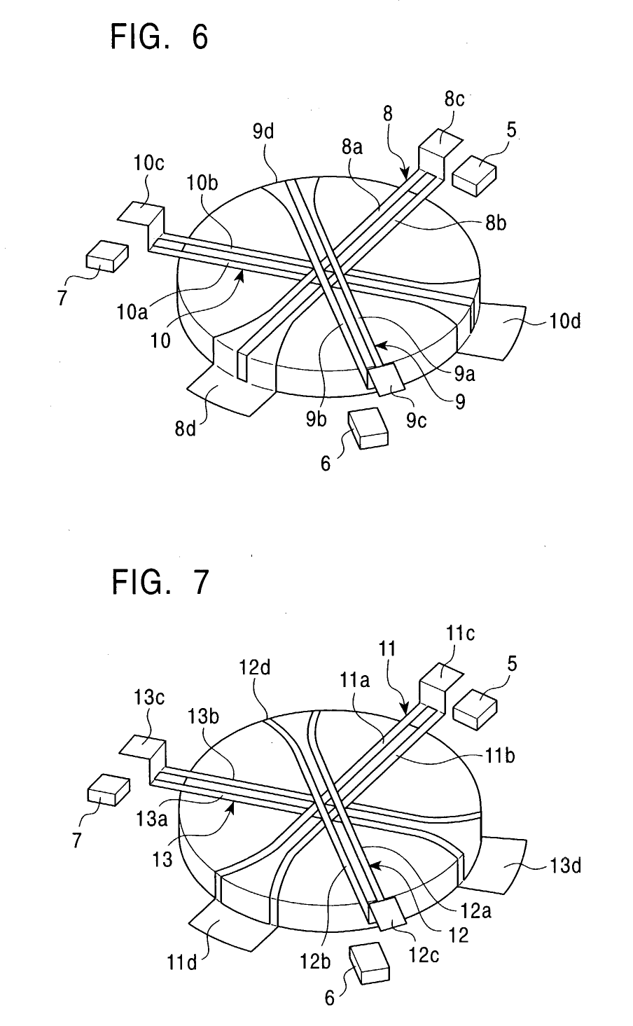

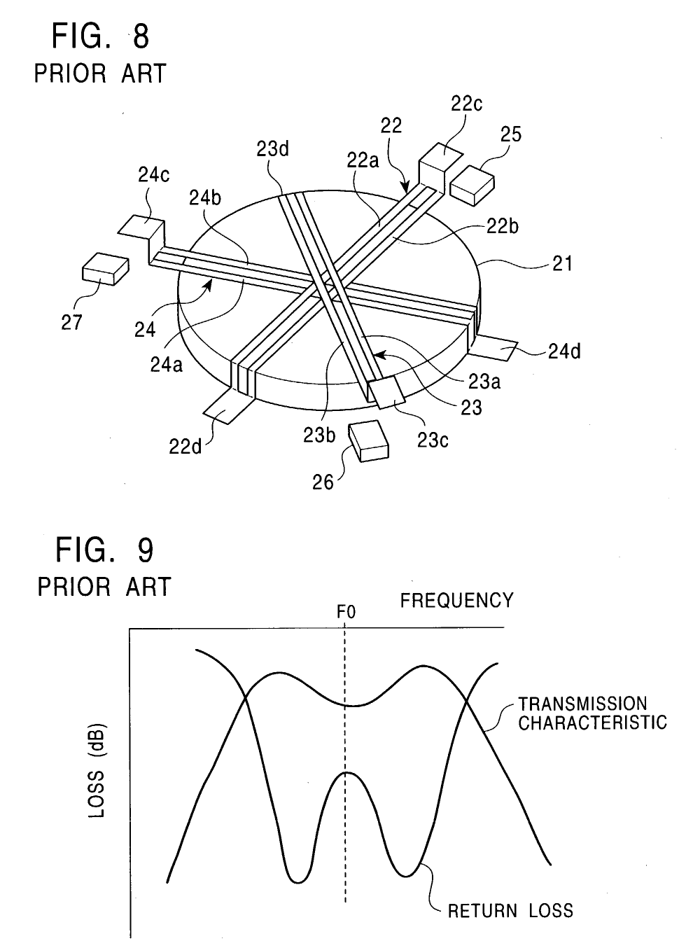

FIG. 6 illustrates a second embodiment of the present invention. In FIG. 6, central conductors 8, 9, and 10 are formed of two opposing conductor portions 8a and 8b, 9a and 9b, and 10a and 10b, respectively. One end of the central conductor 8 serves as an input/output terminal 8c, and the other terminal thereof is used as a ground terminal 8d; one end of the central conductor 9 serves as an input/output terminal 9c, and the other end thereof is used as a ground terminal 9d; and one end of the central conductor 10 serves as an input/output terminal 10c, and the other end thereof is used as a ground terminal 10d. The input/output terminals 8c, 9c, and 10c are connected to corresponding circuits (not shown), and are grounded via the matching capacitors 5, 6, and 7, respectively, which have equal capacitances. The ground terminals 8d, 9d, and 10d are connected to corresponding grounded casings (not shown).

As in the first embodiment shown in FIG. 1, the central conductors 8, 9 and 10 are held so that they overlap with each other at regular intervals (120°) substantially at the center of the top surface of the magnetic core 1 while being insulted from each other.

The two conductor portions 8a and 8b, 9a and 9b, or 10a and 10b oppose each other with an equal spacing, and the width thereof becomes greater toward the ground terminal 8d, 9d, or 10d. With this configuration, the average inductance per unit length from the overlapping portion to the ground terminal 8d, 9d, or 10d of the central conductor 8, 9, or 10 becomes smaller than that from the overlapping central portion to the input/output terminal 8c, 9c, or 10c.

Accordingly, the equivalent circuit of the double-tuned circuit formed between the input/output terminals 8c and 9c can also be indicated as shown in FIG. 4, and thus, the coupling index k expressed by equation (1) becomes smaller. In the second embodiment, the object of the present invention can be achieved without providing short-circuiting strips, which are provided in the first embodiment.

FIG. 7 illustrates a third embodiment of the present invention. In FIG. 7, central conductors 11, 12, and 13 are formed of two opposing conductor portions 11a and 11b, 12a and 12b, and 13a and 13c, respectively. One end of the central conductor 11 serves as an input/output terminal 11c, and the other end thereof is used as a ground terminal lid; one end of the central conductor 12 serves as an input/output terminal 12c, and the other end thereof is used as a ground terminal 12d; and one end of the central conductor 13 serves as an input/output terminal 13c, and the other end thereof is used as a ground terminal 13d. The input/output terminals 11c, 12c, and 13c are connected to corresponding circuits (not shown), and are grounded via matching capacitors 5, 6, and 7, respectively, which have equal capacitances. The ground terminals lid, 12d, and 13d are connected to corresponding grounded casings (not shown).

As in the first embodiment shown in FIG. 1, the central conductors 11, 12, and 13 are held so that they overlap with each other at regular intervals (120°) substantially at the center of the top surface of the magnetic core 1 while being insulated from each other.

The two conductor portions 11a and 11b, 12a and 12b, or 13a and 13b oppose each other with an equal spacing, and the width thereof is the same and the spacing therebetween becomes greater toward the ground terminal 11d, 12d, or 13d. With this configuration, the coupling force between the two conductor portions 11a and 11b, 12a and 12b, or 13a and 13b becomes weaker toward the ground terminal 11d, 12d, or 13d, and thus, the inductance becomes smaller. Accordingly, the average inductance per unit length from the overlapping central portions to the ground terminals 11d, 12d, and 13d of the central conductors 11, 12, and 13 becomes smaller than that from the central portions to the input/output terminals 11c, 12c, and 13c.

In the third embodiment, therefore, the double-tuned circuit formed, for example, between the input/output terminals 11c and 12c can be indicated as shown in FIG. 4, and thus, the coupling index k expressed by equation (1) is decreased.

The configuration of the second embodiment may be applied to the third embodiment. That is, the spacing between the two conductor portions 11a and 11b, 12a and 12b, or 13a and 13b is increased toward the ground terminal 11d, 12d, or 13d, and also, the width thereof is increased toward the ground terminal 11d, 12d, or 13d. With this configuration, the average inductance from the overlapping central portions to the ground terminals 11d, 12d, and 13d of the central conductors 11, 12, and 13 becomes much smaller than that from the central portions to the input/output terminals 11c, 12c, and 13c. Thus, a greater advantage can be exhibited by this modification.

What is claimed is:

1. A nonreciprocal circuit device comprising:
a planar magnetic core disposed in a DC magnetic field, a top surface of said magnetic core being perpendicular to the direction of the DC magnetic field; and
three central conductors disposed to overlap with each other substantially at a central portion of the top surface of said magnetic core, one end of each of said three central conductors being used as an input/output terminal, and the other end thereof being used as a ground terminal,
wherein the inductance per unit length from the central portion to the ground terminal of each of said three central conductors is set to be smaller than the inductance per unit length from the central portion to the input/output terminal of each of said three central conductors.

2. A nonreciprocal circuit device according to claim 1, wherein each of said three central conductors comprises two strip-like conductor portions opposing each other with an equal spacing therebetween, and a short-circuiting strip for connecting the two strip-like conductor portions is provided between the central portion and the ground terminal.

3. A nonreciprocal circuit device according to claim 1, wherein each of said three central conductors comprises two strip-like conductor portions opposing each other, and the width of each of the strip-like conductor portions from the central portion to the ground terminal is set to be greater than the width of each of the strip-like conductor portions from the central portion to the input/output terminal.

4. A nonreciprocal circuit device according to claim 1, wherein each of said three central conductors comprises two strip-like conductor portions opposing each other, and the spacing between the two strip-like conductor portions from the central portion to the ground terminal is set to be greater than the spacing between the two strip-like conductor portions from the central portion to the input/output terminal.

5. A nonreciprocal circuit device according to claim 4, wherein the width of each of the strip-like conductor portions from the central portion to the ground terminal is set to be greater than the width of each of the strip-like conductor portions from the central portion to the input/output terminal.
